(19) United States
(12) Patent Application Publication
(10) Pub. No.: US 2024/0398530 A1
(43) Pub. Date: Dec. 5, 2024

(54) INSTRUMENTS FOR DIRECT BONDED LINGUAL FOR ORTHODONTICS AND RELATED METHODS

(71) Applicant: Alta Smiles LLC, Fort Washington, PA (US)

(72) Inventors: Gary D. GIEGERICH, Fort Washington, PA (US); Amanda M. FRANKS, Fort Washington, PA (US); Talia SHEMESH, Fort Washington, PA (US)

(21) Appl. No.: 18/679,730

(22) Filed: May 31, 2024

Related U.S. Application Data
(60) Provisional application No. 63/470,322, filed on Jun. 1, 2023.

(51) Int. Cl. A61C 19/04; A61C 7/02

(52) U.S. Cl. CPC A61C 19/041; A61C 7/02

(57) ABSTRACT

An assessment tool for assessing whether an orthodontic wire may be bonded to a lingual side of a patient's teeth includes a first leg and a second leg defining an x-shape and a central axis and a first evaluation paddle extending from a first distal end of the first leg. The evaluation paddle has a first flat evaluation surface facing the central axis. The assessment tool also includes a second evaluation paddle extending from a second distal end of the first leg, a third evaluation paddle extending from a first distal end of the second leg and a fourth evaluation paddle extending from a second distal end of the second leg. The first evaluation paddle may be a lower mandibular paddle, the second evaluation paddle may be a maxillary centrals paddle, the third evaluation paddle may be a maxillary lateral incisors paddle and the fourth evaluation paddle may be a mandibular canines paddle.

### CROSS-REFERENCE TO RELATED APPLICATIONS

The present application claims the benefit of U.S. Provisional Patent Application No. 63,470,322; filed Jun. 1, 2023 and titled, “Instruments for Direct Lingual Bonding of Wires for Orthodontics and Related Methods;” the entire contents of which is incorporated herein by reference in its entirety.

### BACKGROUND OF THE INVENTION

Orthodontics is a relatively well established field of manipulating teeth or dealing with the prevention and correction of irregular teeth, typically by means of braces. Bracket and wires, as well as aligners, are the most often used techniques to move the patient's teeth during orthodontic treatment. Removeable appliances are also used such as “retainers” that may have “spring features” to exert pressure on specific teeth while the patient is wearing the appliance. Patients desire discreet alternatives that have a minimal impact on their physical appearance, as well as an understanding of the duration of treatment and the patient's options or eligibility for various treatment options. Clinicians further desire treatment options that produce successful results and are efficient to apply to a patient's teeth. Emerging techniques have been developed, for example by Dr. Benjamin Cassalia as is described in U.S. Pat. No. 10,342,640, to directly bond orthodontic wires to a lingual side of a patient's teeth, although these techniques are not appropriate for all patient's, depending on the amount of misalignment of their teeth, and dental professionals have not developed protocols or systems for determining when a patient is a candidate for orthodontic treatment using directly bonded lingual wires.

It would be desirable to design, implement and deploy a system and instrument(s) that is simple to use and facilitates a determination of whether a patient is a candidate for direct lingual bonding orthodontics and/or the complexity of the patient's case for direct lingual bonding orthodontics. It would also be desirable to design, develop and commercialize instruments and methods that can be used to easily and efficiently position orthodontic wires for lingual bonding to the patient's teeth and hold the wires in a fixed position during the bonding process.

### BRIEF SUMMARY OF THE INVENTION

Briefly stated, a preferred embodiment of the present invention is directed to an assessment tool for assessing whether an orthodontic wire may be bonded to a lingual side of a patient's teeth. The assessment tool includes a first leg and a second leg defining an x-shape. The assessment tool includes a central axis and a first evaluation paddle extending from a first distal end of the first leg. The evaluation paddle has a first flat evaluation surface facing the central axis. The assessment tool also includes a second evaluation paddle extending from a second distal end of the first leg, a third evaluation paddle extending from a first distal end of the second leg and a fourth evaluation paddle extending from a second distal end of the second leg. The first evaluation paddle may be a lower mandibular paddle, the second evaluation paddle may be a maxillary centrals paddle, the third evaluation paddle may be a maxillary lateral incisors paddle and the fourth evaluation paddle may be a mandibular canines paddle.

In another aspect, a preferred embodiment of the present invention is directed to a measurement tool for measuring distances between adjacent teeth of a patient's arches. The measurement tool includes a first leg and a second leg defining an x-shape and a first measurement spike positioned on a first distal end of the first leg. The first measurement spike includes a first pin and a second pin. The first pin is spaced from the second pin at a first distance. The first distance is one to four millimeters.

In a further aspect, a preferred embodiment of the present invention is directed to a wire securement tool for holding an orthodontic wire relative to a lingual surface of a patient's teeth. The wire securement tool includes a thin, strong, flexible string having a first end and a second end and a holding sleeve having a central hole. The first and second ends are configured to thread through the central hole thereby defining a loop at a first end of the holding sleeve. The loop is configured for receiving the orthodontic wire therein. The holding sleeve is movable along the string toward the wire in the loop to apply tension to the string and hold the wire in a predetermined position relative to the patient's teeth with the string extending through a gap between two adjacent teeth. The wire is positioned on a lingual side of the patient's teeth and the holding sleeve is positioned on a facial side of the patient's teeth in a holding configuration.

In an additional aspect, the preferred invention is directed to a wire securement tool for holding an orthodontic wire relative to a lingual surface of a patient's teeth. The wire securement tool includes a thin, strong, flexible string having a first end and a second end and a holding sleeve having a central hole. The first and second ends configured to thread through the central hole thereby defining a loop at a first end of the holding sleeve. The loop configured for receiving the orthodontic wire therein. The holding sleeve movable along the string toward the wire in the loop to apply tension to the string and hold the wire in a predetermined position relative to the patient's teeth with the string extending through a gap between two adjacent teeth, the wire on a lingual side of the patient's teeth and the holding sleeve on a facial side of the patient's teeth. The string may be comprised of dental floss. The holding sleeve may have a cylindrical shape and include first, second and third engagement holes. The central hole may comprise the first, second and third engagement holes.

### BRIEF DESCRIPTION OF THE SEVERAL VIEWS OF THE DRAWINGS

The foregoing summary, as well as the following detailed description of preferred embodiments of the instrument, orthodontic appliance and method of the preferred invention, will be better understood when read in conjunction with the appended drawings. For the purposes of illustrating a case assessment tool, a measurement tool and a wire securement too, there are shown in the drawings preferred embodiments. It should be understood, however, that the application is not limited to the precise arrangements and instrumentalities shown. In the drawings:

FIG. 1 illustrates a side perspective view of an assessment tool in accordance with a first preferred embodiment of the present invention;

FIG. 2 illustrates a lateral perspective view of a patient's arch with the assessment tool of FIG. 1 assessing a lingual surface of an incisal tooth of the patient's arch;

FIG. 3 illustrates a top perspective view of a measurement tool in accordance with a second preferred embodiment of the present invention;

FIG. 4 illustrates a top plan view of wire securement tools mounted to an orthodontic wire in accordance with a preferred embodiment of the present invention;

FIG. 5 illustrates an image of a lingual perspective view of incisor and canine teeth of a patient; and

FIG. 6 illustrates a top perspective view of a wire securement tool in accordance with a preferred embodiment of the present invention, wherein the wire securement tool is attached to an orthodontic tray.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right”, “left”, “lower” and “upper” designate directions in the drawings to which reference is made. The words “inwardly” or “distally” and “outwardly” or “proximally” refer to directions toward and away from, respectively, the patient's body, or the geometric center of the preferred case assessment tool, measurement tool, wire securement tool and related parts thereof. The words, “anterior”, “posterior”, “superior,” “inferior”, “lateral,” “lingual,” facial,” “occlusal,” “maxillary” and related words and/or phrases designate preferred positions, directions and/or orientations in the human body to which reference is made and are not meant to be limiting. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

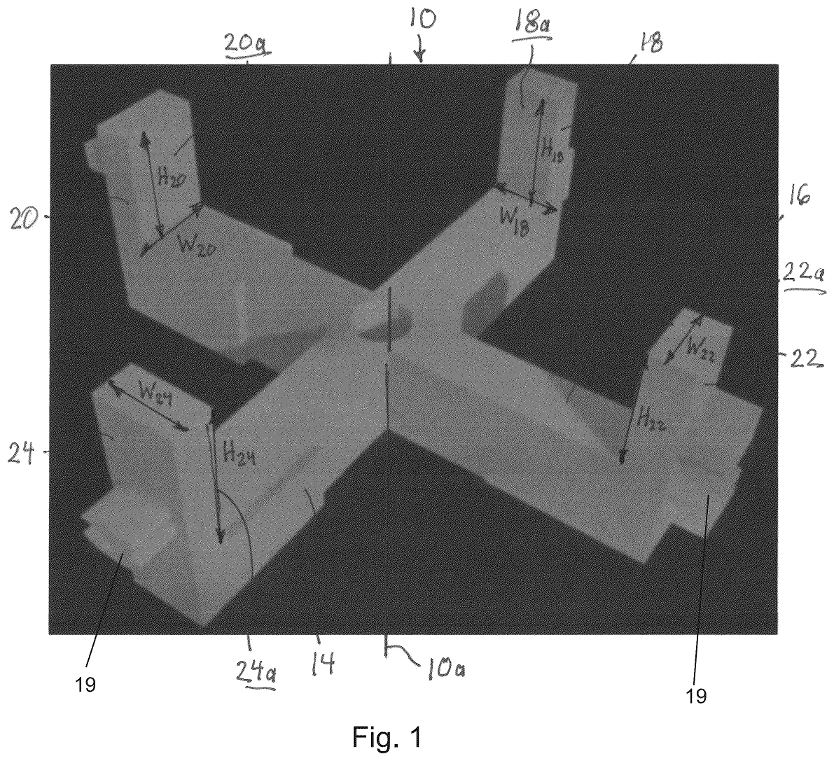

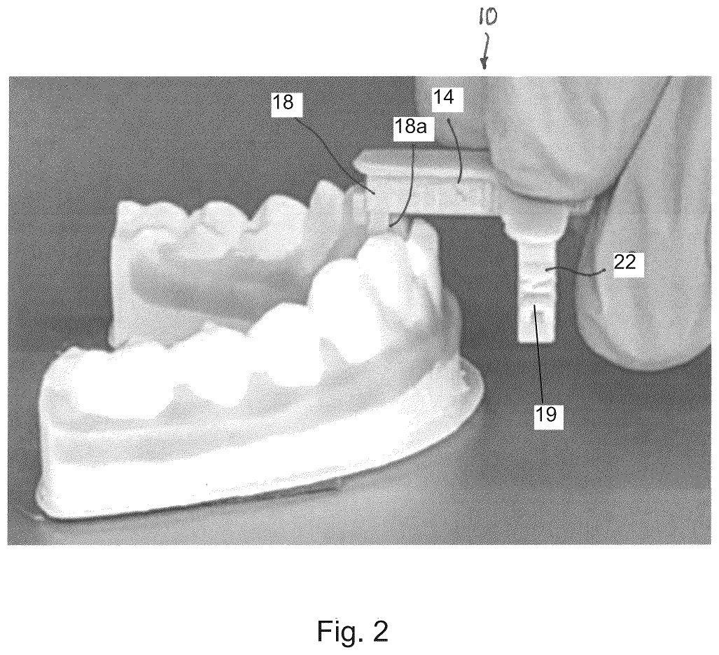

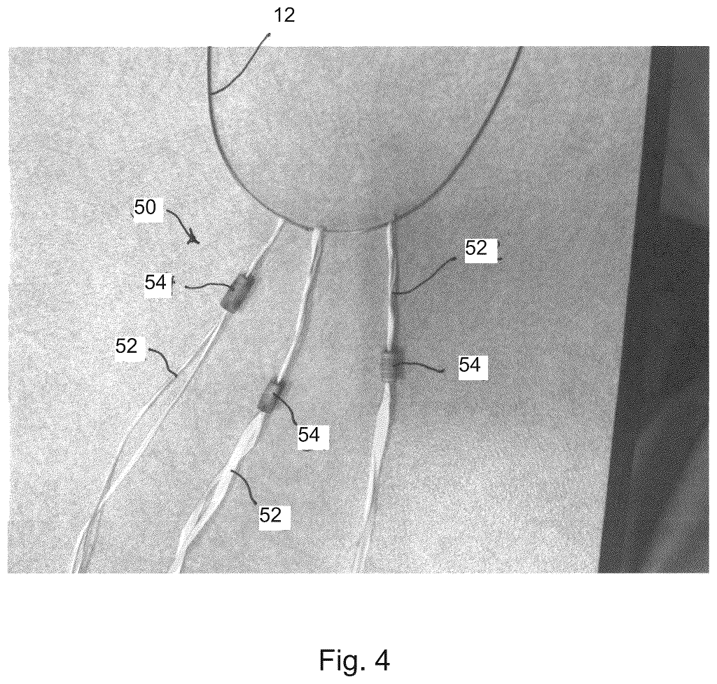

Referring to FIGS. 1 and 2, an assessment tool 10 in accordance with a first preferred embodiment of the present invention is used to determine the appropriateness and/or complexity of an orthodontic procedure for a patient, particularly the appropriateness and/or complexity of applying lingual orthodontic wires 12 (FIG. 4) to lingual surfaces of the patient's teeth. The assessment tool 10 is utilized by a dental professional to readily determine a lingual surface area of the patient's teeth that are available or usable for bonding of the lingual wire 12 to the patient's teeth. This assessment tool 10 may be used to determine whether the wire 12 can be bonded effectively against a lingual tooth surface. The assessment tool 10 is not limited to analysis and review of the lingual surface of the patient's teeth and may be utilized to determine appropriate surface area for bonding to facial surfaces of the patient's teeth and/or for review or analysis of surfaces of the patient's teeth for bonding orthodontic brackets or other appliances to the patient's teeth.

The preferred assessment tool 10 includes two legs 14, 16 that cross in the form of an X-shape with evaluation paddles or width references 18, 20, 22, 24 extending from distal ends of each of the legs 14, 16. The legs 14, 16 are not limited to being fixed in the X-shape and may be otherwise designed and configured based on designer preferences, such as pivotably in and out of a housing, similar to a pocket knife, individually and separately formed or otherwise designed. The evaluation paddles 18, 20, 22, 24 may include a first width reference or lower mandibular paddle 18, a second width reference or maxillary centrals paddle 20, a third width reference or maxillary lateral incisors paddle 22 and a fourth width reference or maxillary and mandibular canines paddle 24. The preferred width reference or evaluation paddles 18, 20, 22, 24 extend at an approximate ninety degree (90°) angle from the distal ends of the legs 14, 16 but are not so limited and may otherwise extend at an alternative angle from the distal ends of the legs 14, 16 or may otherwise be designed and configured for positioning against the lingual side of the patient's teeth, as is described in greater detail herein.

Each of the width references or evaluation paddles 18, 20, 22, 24 preferably includes a generally flat evaluation surface 18a, 20a, 22a, 24a facing a central axis 10a of the assessment tool 10. Each of the evaluation surfaces 18a, 20a, 22a, 24a includes a width W₁₈, W₂₀, W₂₂, W₂₄, each of which are different, and a height H₁₈, H₂₀, H₂₂, H₂₄. In the first preferred embodiment, the widths W₁₈, W₂₀, W₂₂, W₂₄ are in the range of approximately two and one-half to five millimeters (2.5-5 mm) but are not so limited and may be larger or smaller and are preferably each different for evaluating or assessing different teeth in the patient's mouth. The evaluation surfaces 18a, 20a, 22a, 24a with the widths W₁₈, W₂₀, W₂₂, W₂₄ and heights H₁₈, H₂₀, H₂₂, H₂₄ are configured for evaluating different teeth. In the preferred embodiment, the heights H₁₈, H₂₀, H₂₂, H₂₄ are substantially the same but are not so limited and may be different. The preferred heights H₁₈, H₂₀, H₂₂, H₂₄ are in the range of ten to fifteen or more millimeters (10-15 mm) but are not so limited and are preferably sized such that the medical professional can position the evaluation surfaces 18a, 20a, 22a, 24a against the lingual sides of the teeth that are being evaluated or assessed during use. The assessment tool 10 may also be provided having different sizes based on evaluating different patient's having variously sized teeth. The assessment tool 10 is preferably provided in different sizes and having differently sized evaluation surfaces 18a, 20a, 22a, 24a that can be placed directly against the lingual surfaces of the patient's teeth.

The preferred assessment tool 10 has multiple size options on the same device, as described above, but the assessment tool 10 may be a single sized device without the two legs 14, 16 with the four width references or evaluation paddles 18, 20, 22, 24 or may include additional legs with additional evaluation paddles (not shown) to provide further sizes for measuring the patient's lingual teeth surfaces. The assessment tool 10 may also be comprised of a kit of multiple single sized evaluation paddles (not shown) that are strung together with a string or other similar manner of connecting the single evaluation paddles. Any of the embodiments of the paddles and assessment tools 10 may be provided to the dental professional in a sterile package for transport and delivery to the dental professional.

The preferred assessment tool 10 is used to measure specific teeth or a series of teeth of the patient's arches to assess whether the patient is a candidate for direct bonding of the orthodontic wire 12. Each tooth type of the patient's arch has a different shape/morphology, therefore bonding to each tooth has its own challenges, and each of the width references or paddles 18, 20, 22, 24 may be configured for evaluating the lingual surfaces of specific teeth based on designer and medical professional design and bonding considerations, although the width references or paddles 18, 20, 22, 24 may also be designed for evaluating facial surfaces or other surfaces for direct bonding.

The case assessment tool is used to determine if a patient will qualify for treatment utilizing bonded orthodontic wires 12, preferably lingually bonded orthodontic wires 12. The preferred assessment tool 10 determines if a specific tooth has sufficient or adequate surface area to successfully bond the orthodontic wire 12 to the surface during a direct bonding orthodontic technique. Referring to FIG. 2, a tooth that does not have enough surface area exposed for direct bonding may be referred to as being “too blocked out” for use with the directly bonded orthodontic wire technique, which typically bonds the orthodontic wire 12 directly to the lingual side of the patient's teeth. Such a tooth may have its lingual surface further exposed by orthodontic techniques that move the blocked out tooth or the adjacent teeth to expose additional lingual surface before direct lingual bonding is utilized or the patient may be directed to alternative treatment techniques for orthodontic treatment. In the first preferred embodiment, the assessment tool 10 includes the four width references or paddles 18, 20, 22, 24 having different sizes that are preferably used during the assessment of designated or indicated teeth. The preferred width references or paddles 18, 20, 22, 24 may each be labeled with a size. The different width references or paddles 18, 20, 22, 24 may be, but are not so limited, labelled or include size indicia 19, as follows:
lower mandibular paddle 18: “L” used on the six (6) lower anterior teeth mandibular central and lateral incisors;
maxillary centrals paddle 20: “U1” used on the maxillary centrals;
maxillary lateral incisors paddle 22: “U2” used on the maxillary lateral incisors; and
maxillary and mandibular canines paddle 24: “3” maxillary and mandibular canines.

The indicia or labels used for the preferred width references or paddles 18, 20, 22, 24 are not limiting and alternative indicia or labels may be utilized to identify the width references or paddles 18, 20, 22, 24.

In use, the orthodontic professional preferably visually reviews the patient's arch and evaluates potential crowding of the teeth and the general availability of surface area for bonding of the orthodontic wire 12 to the lingual surfaces of each of the patient's teeth. If the teeth for bonding are not blocked out, the dental professional is directed or instructed to bond the orthodontic wire 12 to the patient's teeth, such as the first and second teeth T1, T2, to modify the positioning of the first tooth Tl relative to the second tooth T2 based on a treatment plan. If a tooth is out of alignment in such a way that part of its lingual surface is blocked by adjacent teeth, the assessment tool 10 is preferably utilized for that tooth. The appropriate evaluation surface 18a, 20a, 22a, 24a is placed flat against the lingual side of the specific tooth (FIG. 2). The assessment tool 10 is preferably designed such that if the evaluation surface 18a, 20a, 22a, 24a sits flatly against the lingual surface of the tooth easily, the tooth is not too blocked out for treatment utilizing the lingual bonding of orthodontic wire treatment. If the evaluation surface 18a, 20a, 22a, 24a cannot lie flatly against the lingual side of the tooth for the specific tooth associated with the width references or paddles 18, 20, 22, 24, that tooth may be too blocked out to be treated utilizing conventional bonding techniques for lingual bonding of orthodontic wires 12. The preferred case assessment tools 10 are single use and should be discarded after use but are not so limited and may be sterilized following use with a particular patient. The technique for the assessment tool 10 is also described, but not limited by, the technique guide, which is reproduced below, under the “Defining ‘Blocked Out’ for a Tooth.”

### Defining “Blocked Out” for a Tooth

### Use the C5 Case Assessment Tool for the Following Assessment

Place the C5 Case Assessment Tool against the lingual side of the tooth. If the tool may sit flatly against the lingual surface, the tooth is not considered to be blocked out. If the tool is unable to sit flatly against the lingual surface, the tooth is considered to be blocked out. The uses for each side of the tool are as follows:
L—used on the mandibular central and lateral incisors
U1—used on the maxillary centrals
U2—used on the maxillary lateral incisors
U3—used on the maxillary and mandibular canines

Circle all blocked out teeth on the Case Assessment Form before moving to step 2. Remember that the C5 Case Assessment Tool is single use, and you must always discard the tool after each use.

### C5 X Case Assessment Protocol

### Use the Express Case Assessment Tool for the Following Assessment

Each side of the Express Case Assessment Tool shows a number representing the distance in mm between the points on that side. The distances represented are as follows:
1 mm
2 mm
3 mm.
4 mm

Use the tool to measure the distance between the distal edge of one tooth to the medial edge of its neighboring tool. You will be measuring five points on each arch of the front six teeth. Add up the combined millimeters of each measurement on the arch and note the measurement on the Case Assessment Form. Remember that the Express Case Assessment tool is single use, and you must always discard the tool after each use.

A preferred and non-limiting technique for use of the assessment tool 10 is described in the above technique guide under the “C5 X Case Assessment Protocol” lower section of the technique guide. Aggregating the totals of the distances measured utilizing the measurement tool 30 may be identified and stored on a case assessment chart, which is reproduced below, and the aggregation of the distances may be utilized to determine the viability of treating the patient and the amount of time that the patient may expect to be under treatment utilizing the direct lingual bonding of orthodontic wires treatment protocol. The case assessment chart may be designed, although is not so limited, as follows:

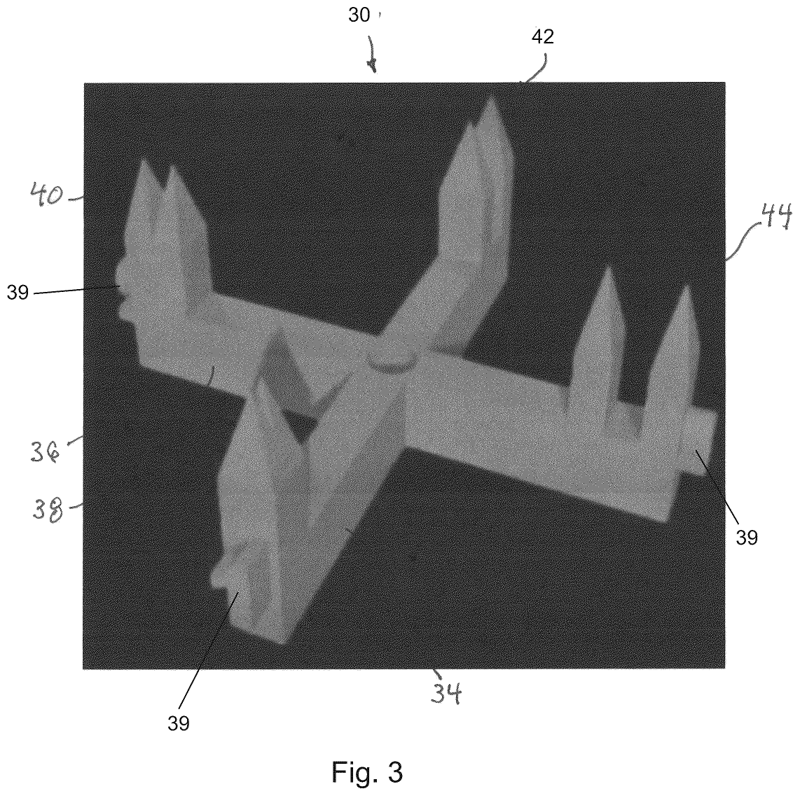

Referring to FIG. 3, a measurement tool 30 of a second preferred embodiment may be utilized to measure distances between a patient's teeth for evaluation of the patient's teeth to determine or assess whether the patient is a candidate for direct lingual bonding of orthodontic wire treatment and for estimating the amount of time the patient is likely going to be under treatment with the direct lingual bonding technique. The measurement tool 30 is preferably used to assess the patient's teeth for direct orthodontic wire 12 bonding and to determine the complexity of a case to achieve desired tooth position(s) and/or alignment.

The measurement tool 30 may include two legs 34, 36 that cross in an X-shape but is not so limited and may be otherwise configured. The two legs 34, 36 of the measurement tool 30 preferably include pairs of distance references or measurement spikes 38, 40, 42, 44 at distal ends of each of the legs 34, 36, respectively. The distance references or spikes 38, 40, 42, 44 are preferably designed and configured in a variety of sizes. In the second preferred embodiment the distance references or spikes 38, 40, 42, 44 are comprised of a first distance reference or 1 mm spike 38, a second distance reference or 2 mm spike 40, a third distance reference or 3 mm spike 42 and a fourth distance reference or 4 mm spike 44 but are not so limited and may be otherwise sized and configured. The distance references or spikes 38, 40, 42, 44 may have pointed ends and clearly visible gaps between the pointed ends that enable measurements of distances between the patient's adjacent teeth to be taken by the medical professional. The distance references of spikes 38, 40, 42, 44 may include distance indicia 39 labelled thereon to indicate the distance represented by the spikes 38, 40, 42, 44, such as “1” for 1 mm, “2” for 2 mm, “3” for 3 mm and “4” for 4 mm.

The measurement device 30 can be used to determine the size of a diastema (distance between just two teeth) that may be too large to close with a specific clinical technique, such as the direct lingual bonding of orthodontic wires technique and a different technique may be recommended to the patient or a combination of treatments may be recommended.

The measurement tool 30 may be used to determine if a case will have an estimated treatment length of equal to or under six months, depending on the aggregation of measurements taken of the patient's teeth. Each distal end of the legs 34, 36 of the measurement tool 30 or each of the distance references or spikes 38, 40, 42, 44 preferably has a number that references the distance in millimeters between the points on the specific distance reference or spike 38, 40, 42, 44. The preferred measurement tool 30 has the following non-limiting distances:
first distance reference or spike 38: one millimeter (1 mm);
second distance reference or spike 40: two millimeters (2 mm);
third distance reference or spike 42: three millimeters (3 mm); and
fourth distance reference or spike 44: four millimeters (4 mm).

The measurement tool 30 is preferably used to measure distances of the distal edge to the mesial edge of the adjacent teeth of the patient's arches for assessing the viability of the patient for the lingually bonded wire treatment and for estimated time to completion of the treatment.

In the preferred but non-limiting technique, the medical professional measures five gaps on each arch of the patient's front teeth and records the distances of the gaps on the assessment chart, which is reproduces above in paragraph 24. The six distances or gaps are preferably added and if the number or total is below, for example six millimeters (6 mm), the case will likely qualify as an express case with an estimated treatment time of six (6) months or less. This assessment, measurement and conclusion are not limiting and the technique and specific recommendation may be different depending on the medical professional's judgment and the patient's specific condition.

The assessment chart, which is reproduced above, is preferably utilized to note any teeth that are blocked out, and to document the distances in millimeters (mm) between the front six (6) teeth, although alternative units of measure may be employed, such as English units. The medical professional also preferably notes if any diastemas exceed two millimeters (2 mm) on the assessment chart.

The case acceptance guides of the preferred assessment chart are meant as screening tools so that a medical professional or practice can quickly determine cases that likely qualify for direct lingual bonding of orthodontic wires treatment, as well as to estimate treatment length. Final determinations as to cases qualifying for direct lingual bonding of orthodontic wire 12 treatments and whether the case will be an express case is preferably determined by the medical professional after digital measurement and analysis of the patient's scans.

Referring to FIGS. 1-3, the preferred embodiments of the assessment tool 10 and the measurement tool 30 use a physical device to make the space determinations, but such assessments and determinations are not limiting. Similar assessments and determinations and/or comparisons may be decided by using software and images of the patient's teeth, as is described further below. In addition, the software may be designed and configured to automatically determine gaps between adjacent teeth and exposed surface areas on the lingual sides of the patient's teeth where direct bonding of the wire 12 may be prescribed to determine if the patient is a candidate for the direct bonding technique and/or to automatically develop a treatment plan using artificial intelligence and/or machine learning at a central processor based on a plurality of images of the patient's teeth.

The assessment and measurement tools 10, 30 may be single use or may also be reusable, such as by sterilization by either a cold sterilization method, with an autoclave machine/device, or utilizing or employing other sterilization methods or techniques.

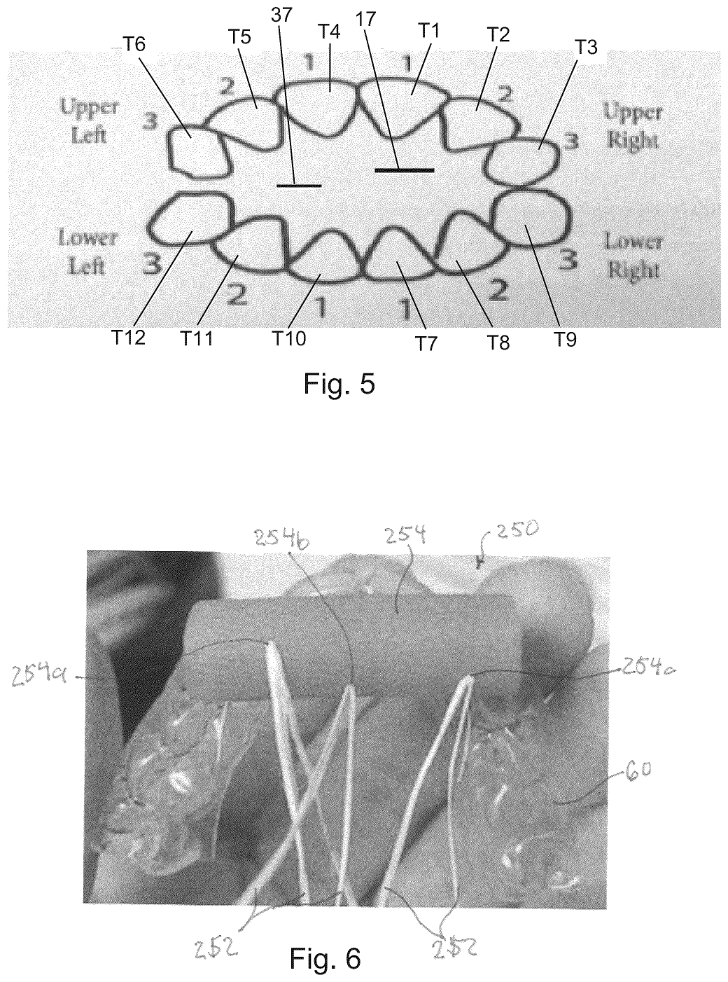

Referring to FIGS. 1-3 and 5, in operation, the preferred invention is utilized to assess whether a patient is eligible for a direct orthodontic wire 12 bonding treatment to align the patient's teeth. The teeth include a first tooth T1 and a second tooth T2, which may be comprised of any adjacent teeth of the patient's teeth but are shown in FIG. 5 as the maxillary right central incisor as the first tooth T1 and the maxillary right lateral incisor as the second tooth T2. The teeth may also include a third tooth or maxillary right canine T3, a fourth tooth or maxillary left central incisor T4, a fifth tooth or maxillary left lateral incisor T5, a sixth tooth or maxillary left canine T6, a seventh tooth or mandibular right central incisor T7, an eighth tooth or mandibular right canine T8, a ninth tooth or mandibular right lateral incisor T9, a tenth tooth or mandibular left central incisor T10, an eleventh tooth or mandibular left canine T11, a twelfth tooth or mandibular left lateral incisor and any additional teeth (not shown) that are part of the patient's teeth. The direct orthodontic wire 12 bonding alignment technique may be configured to align these front teeth or may be designed and configured to align nearly any two or more of the patient's teeth, preferably teeth that are adjacent to each other.

In the preferred method, the width reference or paddle 18, 20, 22, 24 is compared to a first exposed surface on a lingual side of the first tooth T1 to determine if there is sufficient surface area on the lingual side of the first tooth T1 for the direct bonding technique. This comparison may be made with the paddles 18, 20, 22, 24 by placing the evaluation surface 18a, 20a, 22a, 24a against the lingual side of the first tooth T1. If the evaluation surface 18a, 20a, 22a, 24a may rest against the lingual side of the first tooth T1, the first tooth T1 may be utilized for the direct bonding technique. The width reference or paddle 18, 20, 22, 24 may then be compared to a second exposed surface on a lingual side of the second tooth T2 to similarly determine if the evaluation surface 18a, 20a, 22a, 24a may rest against the lingual side of the second tooth T2. If the width reference 18, 20, 22, 24 is unable to rest against the lingual side of the first or second teeth T1, T2, the patient may not be eligible for the direct bonding technique. The teeth that will be bonded in the direct bonding technique are each evaluated for this surface width or at least the teeth where the wire 12 is preferably bonded. Alternatively, the reference width may be comprised a reference mark 17 on an image of the first exposed surface of the first tooth T1. The reference mark 17 may be digitally modified and sized for the patient's different teeth T1, T2, T3, T4, T5, T6, T7, T8, T9, T10, T11 to determine adequate surface area for bonding without requiring physical measurement of the patient's teeth. The reference width 17, 18, 20, 22, 24 is preferably compared to the lingual side of each of the patient's teeth where the wire 12 will be bonded to ensure there is sufficient bonding surface to bond the wire 12.

In the preferred procedure, the distance reference or measurement spikes 38, 40, 42, 44 may be compared to a tooth gap measured between a distal edge of the first tooth Tl and a mesial edge of the second tooth T2. The tooth gap is preferably measured to each of the patient's teeth that will be included in the direct bonding technique to determine whether the patient is a candidate for the direct bonding technique and the provide an estimate of how long the patient may require treatment to produce a preferred alignment with the direct bonding technique. The distance reference may be comprised of the spikes 38, 40, 42, 44 with the pair of points having a fixed distance. The points of the spikes 38, 40, 42, 44 may be positioned on the distal edge of the first tooth T1 and the mesial edge of the second tooth T2 to determine the distance or gap between the adjacent teeth. The distance reference may also be comprised of a distance mark 37 on the image of the patient's teeth (FIG. 5) that is used to measure the distance or gap between the teeth or may be determined by selecting points on the image at the distal edge and mesial edge of adjacent teeth to digitally determine the distance or gap between the adjacent teeth. The gaps between adjacent teeth are preferably measured for each of the teeth that will be included in the direct bonding construct, although such measurement is not limiting. In the preferred method, the distances between adjacent edges of the patient's six upper or lower teeth T1-T12 may be measured and the measured distances added to assist in determining whether the patient is eligible for the direct bonding technique and how long the treatment may take to complete. Measuring the distances between the six front teeth is not limited and the distances between only the first and second teeth T1, T2 may be measured to assess the patient's eligibility for the direct bonding technique and to assist with an evaluation of the amount of time the direct bonding technique may take to adjust the alignment of the patient's teeth.

Referring to FIG. 4, once a patient is identified as a candidate for direct lingual bonding of an orthodontic wire 12 treatment, the orthodontic wire 12 is positioned and bonded to the lingual side of select teeth of the patient's arches to align and straighten the teeth. The orthodontic wire 12 is preferably positioned against the lingual surfaces of the patient's teeth at desired locations while the wire 12 is bonded to the teeth. A wire securement tool 50 may be utilized to hold the wire 12 against the lingual surface of the patient's teeth while the medical professional applies the bonding agent and allows time for the bonding agent to cure. The wire securement tool 50 may include a thin, flexible and strong string 52 and holding sleeves 54 through which the string 52 may be threaded. The wire securement tool 50 may be used to secure the orthodontic wire 12 or segments of the orthodontic wire 12 against the patient's teeth and the wire 12 or segments of the wire 12 during application of bonding agents, such as adhesive, or while the medical professional trims the wires 12.

The securement tool 50 may be used in conjunction with bonding trays to deflect and/or hold/secure the wires 12 during installation using the bonding trays. The securement tool 50 may be delivered to the medical professional pre-installed on the orthodontic wire 12 or retention of the orthodontic wire 12 and attaching the securement tool 50 to the wire 12 may be conducted by the medical professional during the bonding process for the individual patient for ease of quick installation.

In the preferred embodiment, the string 52 may be comprised of dental floss or some other coated strand of material that can be placed between adjacent teeth, wrapped around the wire 12 and engaged by the holding sleeves 54. The string 52 is not limited to being comprised of dental floss but preferably is able to withstand the normal operating conditions of the string 52, perform the preferred functions of the string 52 and take on the general size and shape of the string 52, as is described herein.

In use, pressure on the string 52 from the holding sleeve 54 enables the clinician to slide the holding sleeve 54 relative to the tooth surface to exert and maintain tension on the wire 12 while placing and positioning the wire 12 in the mouth and on the lingual surface of the teeth. The securement tool 50 is preferably easily releasable from the wire 12 when pressure is no longer needed to secure the wire 12 to the teeth, such as when the wire 12 is bonded to the teeth.

The preferred securement tool 50 frees-up the clinician's hands while placing the wires 12 in the patient's mouth, while trimming the wire 12, if necessary, and while applying bonding agent and allowing cure. This permits the medical professional to otherwise manipulate the wire 12 and perform other functions while the wire 12 is held against the lingual surfaces of the patient's teeth.

The holding sleeve 54 preferably surrounds the string 52 during use, such that the securement tool 50 is a self-contained instrument, as opposed to a clamp that exerts pressure but can easily become disconnected from the wire 12 and is, therefore, easy to loosen and difficult to reengage to the orthodontic wire 12. The holding sleeve 54 is not so limited and may be otherwise designed and configured to hold the string 52 in tension against the wire 12 and the teeth and to hold the wire 12 in position relative to the patient's teeth. The holding sleeve 54 may, for example, be comprised of a clamp mechanism used in conjunction with string 52. The clamp (not shown) preferably has an engagement area with sharp spikes that retain the string 52 from sliding through the clamp to secure the wire 12 and the string 52 relative to the patient's teeth during operation.

In use, the string 52 or multiple strings 52 are wrapped around the wire 12 in a loop and the holding sleeve 54 is engaged with the string 52 by threading the ends of the string 52 through a central hole in the holding sleeve 54. The wire 12 is positioned relative to the patient's teeth at the lingual surfaces of the teeth and the medical professional or clinician adjusts the wire 12 to desired or predetermined locations on the lingual surfaces of the teeth. When the wire 12 is positioned at the desired location(s) the medical professional or clinician urges the holding sleeve 54 toward the wire 12 until the holding sleeve 54 meets a facial side of the patient's teeth. The medical professional may exert a desired amount of pressure on the wire 12 by further urging the holding sleeve 54 toward and onto the facial side of the teeth and the wire 12 is held in the desired position. The clinician then applies the adhesive or bonding agent to the wire 12 when it is contacting the lingual side of the teeth or at predetermined locations and the securement tool 50 or securement tools 50 hold the wire 12 in the desired position until the adhesive or bonding agent is cured. The holding sleeve 54 may then be urged away from the patient's teeth and the string 52 may be released from the wire 12.

Referring to FIG. 5, a second preferred embodiment of a wire securement tool 250 may be used to secure the wire 12 to the patient's teeth for subsequent bonding or for holding the wire 12 in an orthodontic tray 60. The second preferred embodiment of the securement tool 250 is described herein utilizing the same reference numbers to identify the same or similar features with a “2” prefix to distinguish the second preferred embodiment from the first preferred embodiment of the wire securement tool 50.

The second preferred securement tool 250 includes a larger holding sleeve 254 that accommodates engagement with multiple strings 252 for engaging and holding the wire 12. The second preferred holding sleeve 254 has a generally cylindrical shape with string engagement holes 254a, 254b, 254c extending through the holding sleeve 254. Ends of the strings 252 may be threaded through the engagement holes 254a, 254b, 254c to form a loop at one side of the holding sleeve 254 through which the wire 12 may be inserted. Drawing the holding sleeve 254 toward the wire 12 creates tension in the strings 252 to engage and secure the wire 12 against the lingual surface of the patient's teeth or in the tray 60 that is used to position and hold the wire 12 in a desired position for bonding to the patient's teeth.

In the second preferred embodiment, the holding sleeve 254 includes first, second and third engagement holes 254a, 254b, 254c to accommodate three strings 252 but is not so limited and may include more or less engagement holes 254 to accommodate various numbers of strings 252 for engaging the wire 12.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for assessing whether a patient is eligible for a direct orthodontic wire bonding treatment to align the patient's teeth including a first tooth and a second tooth, wherein the first tooth is adjacent to the second tooth, the method comprising:
comparing a width reference to a first exposed surface on a lingual side of the first tooth;
comparing the width reference to a second exposed surface on a lingual side of the second tooth; and
instructing a dental professional to bond an orthodontic wire to the first and second teeth to modify alignment of the first tooth relative to the second tooth.

2. The method of claim 1, wherein the width reference is comprised of a first evaluation paddle having a first width, the first width being positioned against the first exposed surface of the first tooth when comparing the width reference to the first exposed surface.

3. The method of claim 2, wherein the first evaluation paddle is comprised of a portion of an assessment tool, the assessment tool including a first leg and a second leg, the first evaluation paddle extending from a distal end of the first leg.

4. The method of claim 1, wherein the width reference is comprised of a reference mark on an image of the first exposed surface.

5. The method of claim 1, further comprising:
comparing a distance reference to a tooth gap measured between a distal edge of the first tooth and a mesial edge of the second tooth

6. The method of claim 5, wherein the distance reference is comprised of a spike with a pair of points, the points positioned on the distal edge of the first tooth and the mesial edge of the second tooth during use.

7. The method of claim 1, further comprising:
determining the first tooth is blocked out if the width reference does not sit flat against the first exposed surface when comparing the width reference to the first exposed surface.

8. The method of claim 1, further comprising:
determining the first tooth is blocked out if the width reference is greater than the first exposed surface when the width reference is a reference mark on an image of the first exposed surface.

9. The method of claim 1, further comprising:
measuring a distance between adjacent edges of six front teeth of the patient's teeth and adding the measured distances.

10. An assessment tool for assessing whether an orthodontic wire may be bonded to a lingual side of a patient's teeth, the assessment tool comprising:
a first leg and a second leg defining an x-shape and a central axis;
a first evaluation paddle extending from a first distal end of the first leg, the evaluation paddle having a first flat evaluation surface facing the central axis.

11. The assessment tool of claim 10, further comprising:
a second evaluation paddle extending from a second distal end of the first leg;
a third evaluation paddle extending from a first distal end of the second leg; and
a fourth evaluation paddle extending from a second distal end of the second leg.

12. The assessment tool of claim 11, wherein the first evaluation paddle has a first width, the second evaluation paddle has a second width, the third evaluation paddle has a third width and the fourth evaluation paddle has a fourth width, the fourth width greater than the third width, the third width greater than the second width and the second width greater than the first width.

13. The assessment tool of claim 12, wherein the first, second, third and fourth widths are approximately two and one-half to five millimeters.

14. The assessment tool of claim 10, wherein the first evaluation paddle is a lower mandibular paddle, the second evaluation paddle is a maxillary centrals paddle, the third evaluation paddle is a maxillary lateral incisors paddle and the fourth evaluation paddle is a mandibular canines paddle.

15. The assessment tool of claim 10, wherein the tool is configured for disposal following sue.

16. The assessment tool of claim 10, wherein the first evaluation paddle includes a first size indicia opposite the first flat evaluation surface.

17. A measurement tool for measuring distances between adjacent teeth of a patient's arches, the measurement tool comprising:
a first leg and a second leg defining an x-shape;
a first measurement spike positioned on a first distal end of the first leg, the first measurement spike including a first pin and a second pin, the first pin spaced from the second pin at a first distance, the first distance being one to four millimeters.

18. The measurement tool of claim 17, further comprising:
a second measurement spike positioned on a second distal end of the first leg;
a third measurement spike positioned on a first distal end of the second leg; and
a fourth measurement spike positioned on a second distal end of the second leg.

19. The measurement tool of claim 18, wherein the second measurement spike defines a second distance, the third measurement spike defines a third distance and the fourth measurement spike defines a fourth distance, the first distance being one millimeter, the second distance being two millimeters, the third distance being three millimeters and the fourth distance being four millimeters.

20. The measurement tool of claim 17, wherein the first measurement spike includes a distance indicia.
